(19) United States
(12) Patent Application Publication
(10) Pub. No.: US 2014/0125471 A1
(43) Pub. Date: May 8, 2014

(54) HAPTIC FEEDBACK SYSTEMS AND METHODS

(71) Applicant: Advanced Input Devices, Inc., Coeur d'Alene, ID (US)

(72) Inventors: Kevin Vance Organ, Hayden, ID (US); Mitchell Butzer, Coeur d'Alene, ID (US)

(73) Assignee: Advanced Input Devices, Inc., Coeur d'Alene, ID (US)

(21) Appl. No.: 14/071,975

(22) Filed: Nov. 5, 2013

Related U.S. Application Data
(60) Provisional application No. 61/722,649, filed on Nov. 5, 2012.

(51) Int. Cl. G06F 3/01

(52) U.S. Cl. CPC G06F 3/016
USPC 340/407.2

(57) ABSTRACT

A haptic feedback device can include a surface magnet and a first electromagnet sufficient to cause the physical movement of the surface magnet along a first axis. One or more individually addressable pin driver circuits may be communicably coupled to the electromagnet. The individually addressable pin driver circuit is selectively switchable into a number of operating modes that includes a current sourcing mode, a current sinking mode, and an impulse mode. A controller is communicably coupled to each of the pin driver circuits via a digital bus. The controller selects an operating mode and one or more parameters for each of the individually addressable pin driver circuits.

### BACKGROUND

1. Technical Field

The present disclosure generally relates to the field of haptic feedback devices, more particularly to haptic feedback devices using an electromagnet to provide haptic feedback.

2. Description of the Related Art

A haptic feedback device provides a bidirectional means for interaction between a device user and a device. Using haptic feedback, a device may provide a user with a tactile and/or force feedback in response to one or more inputs (e.g., a keystroke on a virtual keyboard by a user) or to alert the user to a received signal (e.g., a tactile notification of a received signal or message). Such haptic feedback generally takes the form of a vibration or similar effect and is intended to alert the user to the receipt of an input or the receipt of a signal in nigh noise environments or in environments where an audible acknowledgement is undesirable.

In human/machine interface (“HMI”) terms, a device capable of providing haptic feedback usually provides both tactile and force feedback. Tactile feedback is a term generally applied to sensations felt by the skin, such as the smoothness of silk, the roughness of sandpaper, the temperature of a cup of tea, or the vibration of drumhead. Force feedback tends to reproduce the forces applied to a user's hands as the result of a solid boundary, such as the roundness and weight of a bowling ball.

Many haptic interfaces include vibration devices in which a central mass is oscillated in an applied magnetic field, such is exemplified by the vibration felt when a portable or cellular telephone is placed in SILENT or VIBRATE mode. Such electromagnetic motors generally operate at resonance and provide a limited range of sensations. Such sensations are frequently sensed by the user as a vibration felt across the entire device, again exemplified by the vibration felt when a portable or cellular telephone is placed in SILENT or VIBRATE mode.

Other haptic interfaces include tactile and/or force feedback systems that employ electroactive polymer technology, piezoelectric technology, electrostatic technology, or subsonic audio wave technology. Such electronic haptic feedback technologies can provide a variable frequency range, response time and intensity haptic feedback effect to only a portion of the device. Other haptic feedback devices use a reverse electro-vibration technique in which a weak current is sent from a user carried device, through the user, to the interface, and then to ground. The passage of the electric field around the fingers creates a variable sensation of textures and/or friction at the user's fingertips.

Haptic interfaces represent sophisticated devices that require a number of input sensors and output devices to generate and provide appropriate feedback based at least in part on an input data provided by the device user. Based on the received input data provided by the device user, a haptic controller responsible for providing tactile and/or force feedback to the user first determines whether a tactile and/or a force feedback response is appropriate. After determining that a tactile and/or a force feedback response is/are appropriate, the haptic controller determines one or more specific characteristics of the tactile and/or force feedback response, such as feedback duration and/or intensity.

### BRIEF SUMMARY

Touchscreen interfaces are gaining widespread acceptance in both the commercial and industrial sectors for their flexibility, intuitiveness, and ease of use. Touchscreen interfaces are easily reprogrammed to accommodate minor to major changes in information provided to a user and/or changes in one or more controlled processes. With their inherent flexibility and programmability, touchscreen interfaces provide a convenient and efficient to panel boards and/or control consoles filled with indicators, recorders, loop controllers, selector switches, pushbuttons, and other analog and/or digital control devices.

While touchscreens provide an accurate virtual representation of devices such as pushbuttons, selector switches, knobs, dials, slide switches and the like, touchscreens have been unable to provide the “feel” of such devices. In many instances, the tactile feedback provided to a user by a discrete control device such as a pushbutton, selector switch, knob, dial, or slide switch provides an important confirmation or acknowledgement that the system has received the entered command or action. Differentiating between a user input provided by one of a number of displayed touchscreen devices on systems offering only simple vibratory tactile response or haptic feedback requires the user to visually confirm the system has received the intended input. For example, on a touchscreen displaying an emergency shutdown pushbutton proximate a multi-position selector switch, a simple vibratory feedback may require the user to look at the touchscreen to actually confirm which device received the input.

The ability to provide a user with haptic feedback mimicking the physical action of a mechanical device beneficially provides the user with meaningful haptic feedback enabling the user to readily discern which touchscreen element received the input without requiring a visual confirmation of the input by the user. For example, user actuation of a virtual pushbutton displayed on the touchscreen may cause the touchscreen to displace downward and upward along an axis normal to the touchscreen and with a sensible “latch” effect that simulates the physical closing or sealing of contacts in a conventional, mechanical pushbutton device. In another example, user actuation of a virtual selector switch displayed on the touchscreen may cause the touchscreen to displace in a rotational manner and with a sensible force feedback that simulates the physical force required to rotate a conventional mechanical selector switch.

Such systems may also provide the use with a variety of different “textures” mad possible by controlling the displacement and/or intensity of the direction, amplitude, and/or frequency of motion of the touchscreen in a three-dimensional space. For example, such a system may reproduce the coarse feeling of sand (e.g., using a random, relatively large displacement in random directions, and at a relatively low frequency) or the smooth feeling of talcum powder (e.g., using a regular, relatively small displacement in a limited number of directions, and at a relatively high frequency). By extending control of the touchscreen to heretofore unprecedented levels, the touchscreen becomes significantly more representative of the physical world, providing the user with enhanced feedback capabilities and extending the utility of the touchscreen across multiple applications.

The haptic effects generator includes a surface magnet that that is driven by one or more electromagnets. In some instances, the electromagnet may include a single electromagnet positioned such that the displacement of the surface magnet is generally limited to a single axis. In other instances, the electromagnet may include multiple electromagnets positioned such that the displacement of the surface magnet is possible within a two-dimensional or even a three-dimensional space.

The field produced by each of the electromagnets determines the physical movement or displacement of the surface magnet. The field produced by each of the electromagnets also determines the haptic feel or texture of the touch surface to the user. The field produced by each of the electromagnets may be controlled using one or more individually addressable pin driver circuits, each having a number of switchable operating modes, communicably coupled to each of the electromagnets controlling the motion of the surface magnet. Each of the pin driver circuits may include any number of systems, circuits, or devices capable of affecting one or more electromagnet field parameters, such as the polarity, direction, and/or frequency of the magnetic field produced by the electromagnet. Each of the pin driver circuits may include one or more switching circuits or devices to selectively energize each electromagnet via the one or more systems, circuits, or devices. Each of the pin driver circuits may also include one or more communication interfaces to communicably couple the pin driver circuit to one or more controllers.

The use of a central controller to selectively switch each of the pin driver circuits enables the generation of a virtually unlimited number of haptic effects or textures. Different magnetic fields, and consequently different haptic effects are provided using different switchable operating modes. For example, a first switchable operating mode may include a current sourcing circuit in which a selectable current value may be chosen by a controller to provide a desired haptic feedback effect such as causing a defined physical displacement of the surface magnet by generating a repulsive magnetic field. In another example, a second switchable operating mode may include a current sinking circuit in which a selectable current value may be chosen by a controller to provide a desired haptic feedback effect such as causing a defined physical displacement of the surface magnet by generating an attractive magnetic field.

In yet another example, a third switchable operating mode may include a switchable capacitor network. The switchable capacitor network can include any number of individually addressable switchable capacitor banks each containing a similar or different number of capacitive elements. The controller may cause the selective charging and discharging of some or all of the switchable capacitor banks. Through the selective control or adjustment of the charge time, discharge time, and discharge frequency for each individually addressable capacitor bank, the controller may provide virtually any haptic feedback that includes a vibratory or oscillatory physical displacement of the surface magnet. Such a vibratory or oscillatory physical displacement permits the generation of haptic output in virtually any direction and having virtually any amplitude, and/or frequency, making possible the simulation of a wide variety of textures and surfaces.

A haptic interface system may be summarized as including: at least one surface magnet; and a haptic interface driver subsystem including: an electromagnet to cause physical movement of the surface magnet in one or more defined directions along a first axis; and at least one individually addressable pin driver circuit operably coupled to the electromagnet, the individually addressable pin driver circuit selectively switchable into one of a number of operating modes each of which causes a different physical movement of the surface magnet along the first axis; at least one digital control bus communicably coupled to the at least one individually addressable pin driver circuit at least one controller communicably coupled to the digital control bus, the at least one controller to individually address and selectively switch each of the individually addressable pin driver circuits into one of the number of operating modes.

The haptic interface system may further include: machine executable instructions stored in at least one nontransitory storage medium communicably coupled to the at least one controller, that when executed by the at least one controller cause the at least one controller to: for each of the pin driver circuits: select a pin driver circuit operating mode from the number of operating modes; determine one or more pin driver circuit operating parameters to cause the physical movement of the surface magnet in the one or more defined directions along the first axis at: a defined frequency, a defined amplitude, or both a defined frequency and a defined amplitude; logically associate the determined one or more pin driver circuit operating parameters with the selected pin driver circuit operating mode; and communicate the selected pin driver circuit operating mode and the logically associated determined one or more pin driver circuit operating parameters to the respective pin driver circuit via the digital control bus. The machine executable instructions may further cause the at least one controller to: autonomously select a pin driver circuit operating mode from the number of operating modes; and autonomously determine one or more pin driver circuit operating parameters to cause the physical movement of the surface magnet in the one or more defined directions along the first axis. The haptic interface system may further include a touchscreen display device operably coupled to the surface magnet, that at times during operation displays representations of one or more human-actuatable devices, each of the displayed human-actuatable devices having stored in the at least one nontransitory storage medium at least one logically associated physical movement. The machine executable instructions that cause the at least one controller to select a pin driver circuit operating mode from the number of operating modes may further cause the at least one controller to: detect a human actuation of a device displayed on the touchscreen display device; autonomously determine the at least one physical movement logically associated with the detected human-actuated device; autonomously select a pin driver circuit operating mode from the number of operating modes sufficient to cause the at least one physical movement logically associated with the detected human-actuated device; and autonomously determine one or more pin driver circuit operating parameters sufficient to cause the at least one physical movement logically associated with the detected human-actuated device. The haptic interface driver subsystem may further include: a number of pairs of opposed electromagnets, each of the pairs of opposed electromagnets to cause physical movement of the surface magnet in one or more defined directions along a respective second axis, the second axis orthogonal to the first axis; at least one individually addressable pin driver circuit operably coupled to each electromagnet in each pair of opposed electromagnets, the individually addressable pin driver circuit selectively switchable into one of a number of operating modes each of which causes a different physical movement of the surface magnet along the respective second axis; and wherein the at least one controller may individually address and selectively switch each of the pin driver circuits into one of the number of operating modes. The haptic interface system may further include: machine executable instructions stored in at least one nontransitory storage medium communicably coupled to the at least one controller, that when executed by the at least one controller cause the at least one controller to: for each of the pin driver circuits operably coupled to each pair of opposed electromagnets: select a pin driver circuit operating mode from the number of operating modes; determine one or more pin driver circuit operating parameters to cause the physical movement of the surface magnet in the one or more defined directions along the respective second axis at: a defined frequency, a defined amplitude, or both a defined frequency and a defined amplitude; logically associate the determined one or more pin driver circuit operating parameters with the selected pin driver circuit operating mode; and communicate the selected pin driver circuit operating mode and the logically associated determined one or more pin driver circuit operating parameters to the respective pin driver circuit via the digital control bus. The machine executable instructions may further cause the at least one controller to: autonomously select a pin driver circuit operating mode from the number of operating modes; and autonomously determine one or more pin driver circuit operating parameters to cause the physical movement of the surface magnet in the one or more defined directions along the second axis. The haptic interface system may further include a touchscreen display device operably coupled to the surface magnet, that at times when in operation displays representations of one or more human-actuatable devices, each of the displayed human-actuatable devices having stored in the at least one nontransitory storage medium at least one logically associated physical movement. The machine executable instructions that cause the at least one controller to select a pin driver circuit operating modes for the electromagnet and for the electromagnets in each pair of opposed electromagnets may further cause the at least one controller to: detect a human actuation of a device displayed on the touchscreen display device; autonomously determine the at least one physical movement logically associated with the detected human-actuated device; for each of the pin driver circuits operably coupled to the electromagnet, autonomously select a pin driver circuit operating mode from the number of operating modes sufficient to cause the at least one physical movement along the first axis logically associated with the detected human-actuated device; for each of the pin driver circuits operably coupled to the electromagnet, autonomously determine one or more pin driver circuit operating parameters sufficient to cause the at least one physical movement along the first axis logically associated with the detected human-actuated device; for each of the pin driver circuits operably coupled to the electromagnets in each pair of opposed electromagnets, autonomously select a pin driver circuit operating mode from the number of operating modes sufficient to cause the at least one physical movement along each respective second axis logically associated with the detected human-actuated device; and for each of the pin driver circuits operably coupled to the electromagnets in each pair of opposed electromagnets, autonomously determine one or more pin driver circuit operating parameters sufficient to cause the at least one physical movement along each respective second axis logically associated with the detected human-actuated device. The surface magnet may include an electromagnet. The haptic interface driver subsystem may further include: at least one individually addressable surface pin driver circuit operably coupled to the surface electromagnet, the individually addressable surface pin driver circuit selectively switchable into one of a number of operating modes; and wherein the at least one controller individually addresses and selectively switches the surface pin driver circuit into one of the number of operating modes.

A haptic interface driver system may be summarized as including: a first electromagnet; at least one controller; a digital bus communicably coupled to the at least one controller; and an individually addressable first pin driver circuit operably coupled to the first electromagnet and communicably coupled to the digital bus, the individually addressable first pin driver circuit selectively switchable by the at least one controller to one of a number of operating modes, each of the operating modes sufficient to cause the first electromagnet to output a magnetic field.

The number of operating modes may include: a current sourcing operating mode in which the first pin driver circuit causes the first electromagnet to output a first magnetic field; a current sinking operating mode in which the first pin driver circuit causes the first electromagnet to output a second magnetic field, the second magnetic field different from the first magnetic field; and an impulse operating mode in which the first pin driver circuit causes the first electromagnet to output a third magnetic field. The third magnetic field outputted by the first electromagnet may be a variable intensity field. The first pin driver circuit may include a number of switched capacitor networks, each of the switched capacitor networks including a number of individually addressable capacitive elements. The impulse operating mode may include operably coupling a switched capacitor network to the first electromagnet; and wherein the at least one controller causes at least some of the number of individually addressable capacitive elements in the switched capacitor network to substantially simultaneously discharge. The impulse operating mode may include operably coupling a plurality of switched capacitor networks to the first electromagnet; and wherein the at least one controller may cause in an alternating pattern: some or all of the number of capacitive elements in at least a first of the plurality of switched capacitor networks to discharge while some or all of the number of capacitive elements in at least a second of the plurality of switched capacitor networks charge; and some or all of the number of capacitive elements in at least the first of the plurality of switched capacitor networks to charge while some or all of the number of capacitive elements in at least the second of the plurality of switched capacitor networks discharge. The at least one controller may communicate one or more operating parameters to the first pin driver circuit via the digital bus, the one or more operating parameters including at least data indicative of an intensity of the first magnetic field. The at least one controller may communicate one or more operating parameters to the first pin driver circuit via the digital bus, the one or more operating parameters including at least data indicative of an intensity of the second magnetic field. The at least one controller may communicate one or more operating parameters to the first pin driver circuit via the digital bus, the one or more operating parameters indicative of at least: an impulse frequency; and an intensity of the third magnetic field for at least a portion of an impulse.

A haptic interface method may be summarized as including: selecting by a controller at least one of a number of individually addressable pin coil driver circuits operably coupled to one or more electromagnets, the one or more electromagnets sufficient to cause a physical movement of a surface magnet; selecting by the controller a pin coil driver circuit operating mode for each of the number of individually addressable pin coil driver circuits, the selected pin coil driver circuit operating mode causing the respective operably coupled electromagnet to generate a magnetic field sufficient to cause the physical movement of the surface magnet; selecting by the controller one or more pin coil driver circuit operating parameters for each of selected pin coil driver circuit operating modes, the selected one or more pin coil driver circuit operating parameters causing the respective operably coupled electromagnet to generate a magnetic field sufficient to cause the physical movement of the surface magnet; and communicating by the controller to each respective individually addressable pin coil driver circuit, switching data sufficient to cause the respective pin coil driver circuit to switch into the selected operating mode and data indicative of the one or more respective pin coil driver circuit operating parameters.

The haptic interface method may further include: displaying a number of user-actuatable devices on a touchscreen display device, each of the number of user-actuatable devices logically associated with a physical movement along at least one of a first axis and a second axis; receiving by a controller an input indicative of a user actuation of a user-actuatable device; and responsive to the receipt of the input indicative of the user actuation of the user-actuatable device, determining by the controller the physical movement logically associated with the user-actuatable device. Displaying a number of user-actuatable devices on a touchscreen display device may include: displaying a number of user-actuatable devices on a touchscreen display device operably coupled to the surface magnet. Selecting by the controller a pin coil driver circuit operating mode for each of the number of individually addressable pin coil driver circuits may include: selecting by the controller a pin coil driver circuit operating mode for each of the number of individually addressable pin coil driver circuits, the pin coil driver circuit operating mode including at least one of: a current sourcing mode, a current sinking mode, or an impulse mode.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1A is a block diagram of an illustrative haptic feedback system in which a surface magnet is displaced by an electromagnet using two controller operated pin driver circuits, according to one illustrated embodiment.

FIG. 1B is a block diagram of an illustrative haptic feedback system in which a surface electromagnet is displaced by an electromagnet using two controller operated pin driver circuits, according to one illustrated embodiment.

FIG. 2A is a schematic of an illustrative haptic feedback system in which a surface magnet is displaced by an electromagnet using two controller operated pin driver circuits and a pair of electromagnets, according to one illustrated embodiment.

FIG. 2B is a schematic of an illustrative haptic feedback system in which a surface magnet is displaced by an electromagnet using two controller operated pin driver circuits and two pairs of electromagnets, according to one illustrated embodiment.

FIG. 3 is a block diagram of an illustrative pin driver circuit useful for supplying current to an electromagnet used in a haptic feedback system, according to one illustrated embodiment.

FIG. 4A is a perspective view of an illustrative touchscreen haptic interface system using a touchscreen surface coupled operably coupled to the haptic feedback system described in detail in FIGS. 1-3, according to one illustrated embodiment.

FIG. 4B is a cross-sectional elevation along line 4B-4B of the illustrative touchscreen haptic interface system shown in FIG. 4A; depicted in the cross-sectional elevation are suspension system elements that flexibly couple the touchscreen surface to a surrounding bezel, according to one illustrated embodiment.

FIG. 5 is a high level logic flow diagram of an illustrative haptic feedback system such as those described in detail with respect to FIGS. 1-4, according to one illustrated embodiment.

FIG. 6 is a high level logic flow diagram of an illustrative haptic feedback system operably such as those described in detail with respect to FIGS. 1-4 that is operably coupled to a touchscreen display device, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with and/or specific construction details of associated with electromagnets, processors, controllers, amplifiers, capacitive devices, capacitive switching networks, touchscreen technology, and graphical display devices have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive, sense that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Unless the context makes clear otherwise, the term “electromagnet” as used herein refers to an electrical coil capable of producing a magnetic field. Such magnets may include any number of coils, for example two or more coils. In such instances, one or more pin driver circuits as described herein may be electrically coupled to each electrical coil forming all or a portion of a particular electromagnet.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

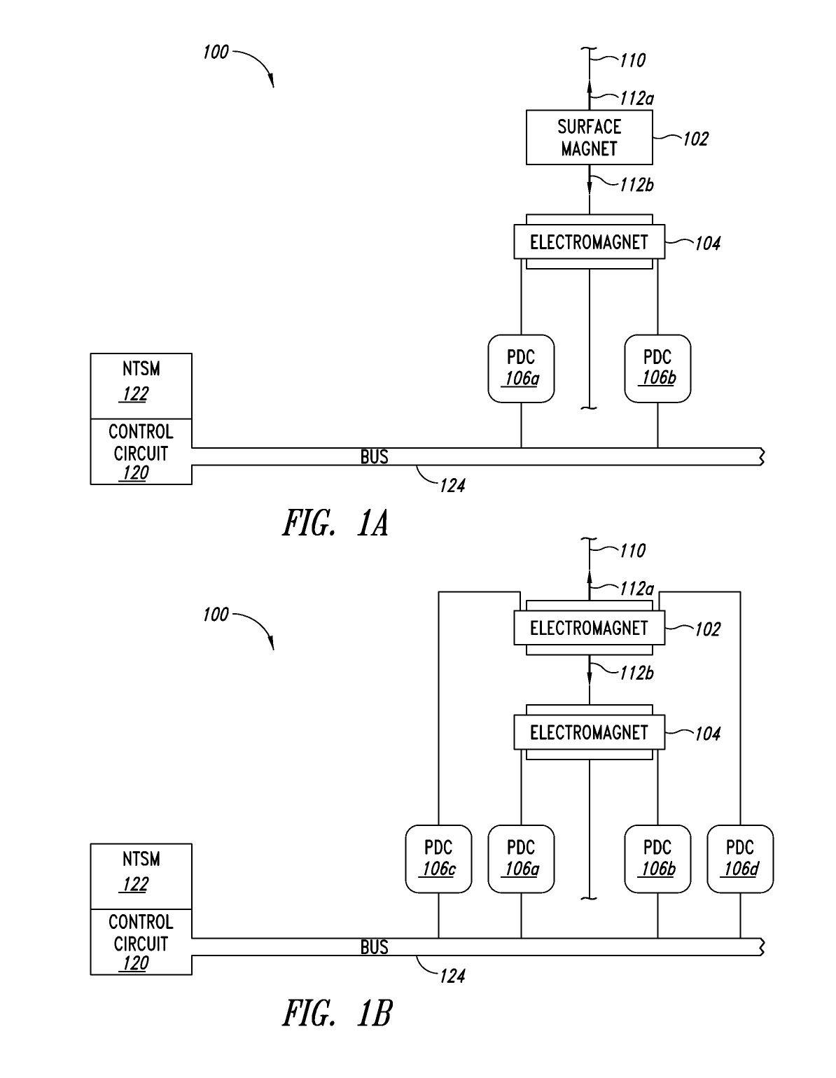

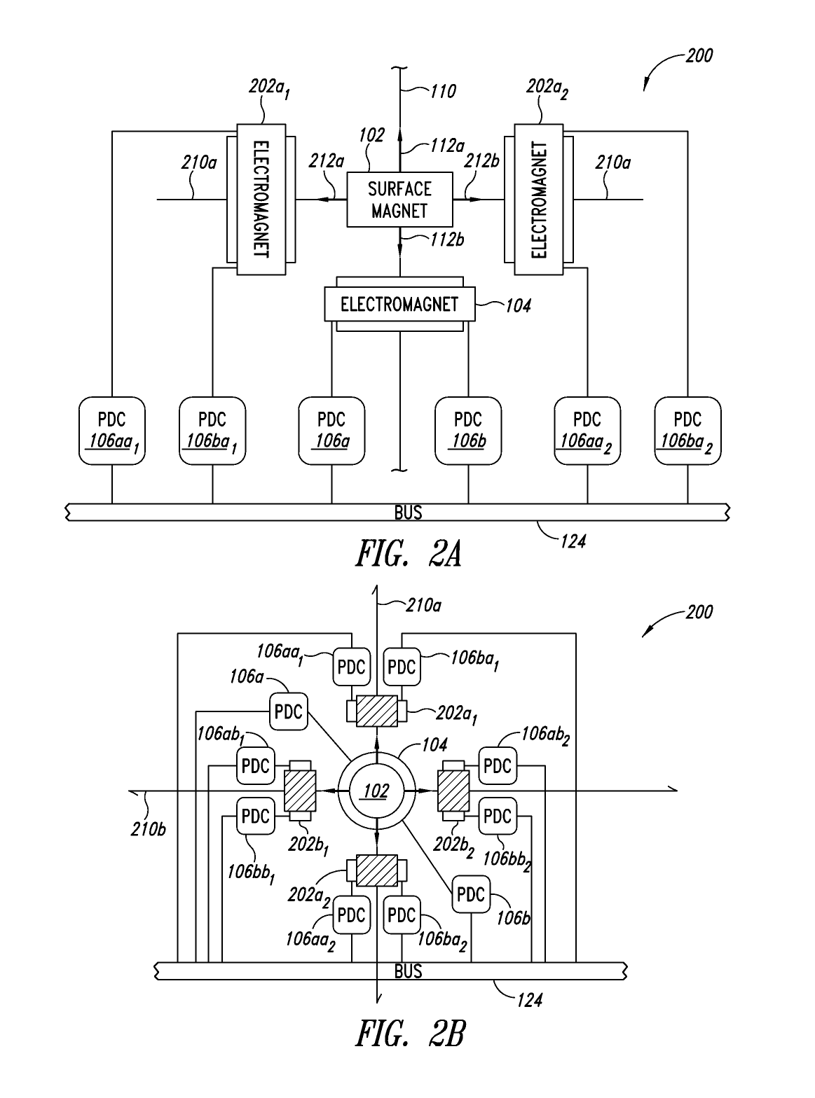

FIGS. 1A and 1B show an illustrative haptic feedback system 100 that includes a surface magnet 102 that is driven by the magnetic fields produced by an electromagnet 104, according to an illustrated embodiment. FIG. 1A depicts an implementation where the surface magnet 102 includes one or more permanent magnets. FIG. 1B depicts a similar implementation where the surface magnet 102 includes one or more electromagnets.

In FIG. 1A, the magnetic fields produced by the electromagnet 104 are controlled at least in part by a number of pin driver circuits 106a-106b (collectively, “pin driver circuits 106”). In at least some instances, the output of the pin driver circuits 106 is adjusted or controlled using one or more control circuits 120. The one or more control circuits 120 may execute one or more sets of machine executable instructions stored in a communicably coupled nontransitory storage medium 122. The output generated by the one or more control circuits 120 is communicated to each communicably coupled pin driver circuit 106 via one or more digital buses 124. In at least some instances, the magnetic field produced by the electromagnet 104 may cause a physical displacement of the surface magnet 102 in one or more directions 112a-112b along a first axis 110 normal to the surface magnet 102 and the electromagnet 104.

In FIG. 1B, the magnetic fields produced by the surface magnet 102 are not the fixed magnetic fields produced by a permanent magnet, but instead include one or more variable magnetic fields produced by an electromagnet. The magnetic fields produced by the surface electromagnet 102 are selectively controlled at least in part by a number of pin driver circuits 106c-106d (collectively, “pin driver circuits 106”). In at least some instances, the output of the pin driver circuits 116 is adjusted or controlled by one or more control circuits 120 using one or more sets of machine executable instructions stored in a nontransitory storage medium 122 communicably coupled to the one or more control circuits 120. The output provided by the one or more control circuits 120 is communicated to each of the communicably coupled pin driver circuits 106 via one or more digital buses 124. In at least some instances, the magnetic field produced by the surface electromagnet 102 enables the displacement of the surface electromagnet 102 in one or more directions difficult or impossible to accomplishing using only the electromagnet 104.

In some implementations, the surface magnet 102 may be operably and/or physically coupled to a touchscreen surface (not shown in Figurel) to provide haptic feedback capability to the touchscreen surface. In implementations where the surface magnet 102 includes one or more current or future developed materials displaying permanent magnetic properties such as that depicted in FIG. 1A, the surface magnet 102 can include, but is not limited to, one or more ferrite magnets, neodymium magnets, plastic magnets, rare-earth magnets, samarium-cobalt magnets, or combinations thereof.

In implementations where the surface magnet 102 includes one or more electromagnets (i.e., is a “surface electromagnet 102”), one or more pin driver circuits 106 may control the flow of current to some or all of the coils forming the surface electromagnet 102, and consequently to control the size, shape, and/or intensity of the magnetic field(s) produced by the surface electromagnet 102. In some implementations, the surface electromagnet 102 may include or incorporate any number of discrete coils or windings. In such instances, the coils and windings in the surface electromagnet 102 may be arranged in any electrical configuration including series, parallel, and series-parallel to achieve different magnetic field patterns by selectively controlling the energization and/or current flow to the various coils via the pin driver circuits 106c-106d.

One or more pin driver circuits 106 are communicably coupled to the electromagnet 104 to control the flow of current to some or all of the coils or windings, and consequently to control the size, shape, and/or intensity of at least a portion of the magnetic field(s) produced by the electromagnet 104. By controlling the size, shape, intensity, changes, and/or rate of change of at least a portion of the magnetic field(s) produced by the electromagnet 104, the electromagnet 104 can cause a variety of physical displacements or movements of the surface magnet 102. In some instances, the electromagnet 104 may include or incorporate any number of discrete coils or windings. In such instances, some or all of the coils or windings forming the electromagnet 104 may be arranged in any electrical configuration including series, parallel, and series-parallel to selectively achieve different magnetic field patterns. Such magnetic field patterns may be generated by varying one or more parameters of the power supplied to the coils or windings forming the electromagnet 104. For example, a number of pin driver circuits 106a-106b coupled to each of the coils or windings forming the electromagnet 104 may have a number of switchable or selectable operating modes to control or otherwise adjust one or more parameters affecting one or more of the following: the energization duration of some or all of the coils or windings, the energization frequency of some or all of the coils or windings, the current flow and/or direction through some or all of the coils or windings, the voltage waveform supplied to some or all of the coils or windings, or any combination thereof.

Each of the pin driver circuits 106 can include any number of components, devices, systems, or circuits capable of affecting or otherwise influencing one or more parameters of the power supplied to the communicably coupled electromagnet. Each pin driver circuit 106 may be capable of selectively entering or switching into one of any number of discrete operating modes. Each of the respective operating modes may include one or more adjustable parameters selected and/or specified by the one or more control circuits 120. For example, in at least some implementations, the pin driver circuit 106 may include at least one constant current output operating mode in which the current supplied to the electromagnet 104 is maintained at a defined level sufficient to cause the electromagnet 104 to produce a more-or-less static magnetic field. In at least some implementations, the one or more control circuits 120 individually address each of the pin driver circuits 106, thereby enabling the one or more control circuits 120 to adjust the power supplied to the coils or windings in an electromagnet to produce a magnetic field sufficient to cause the displacement of the surface magnet 102 in a defined direction, at a defined rate, and for a defined duration. Such flexibility and control of the physical movement of the surface magnet 102 permits a touch surface coupled to the surface magnet 102 to advantageously reproduce a wide variety of textures and movements detectable as haptic feedback by a user.

In at least some instances, a nontransitory storage medium 122 communicably coupled to the one or more control circuits 120 may include one or more sets of machine executable instructions that cause the one or more control circuits 120 to select one or more operating modes for some or all of the pin driver circuits 106 communicably coupled to a digital communication bus 124. In some implementations, the event may include the receipt by the one or more control circuits 120 of one or more user inputs provided to a touchscreen interface, such as a user pressing a pushbutton displayed on the interface. Responsive to the receipt of a signal indicative of a user actuation of the displayed pushbutton, the machine executable instruction set may cause the controller to select operating modes for each of the pin driver circuits to provide haptic feedback to the use that simulates the physical movement or action of a mechanical pushbutton switch.

The one or more control circuits 120 can include any circuit, component, device, or combination of circuits, components, and/or systems capable of executing one or more machine executable instruction sets to control the operation of any number of pin driver circuits 106. The one or more control circuits 120 may include one or more logic processing units, such as one or more central processing units (CPUs), digital signal processors (DSPs), application-specific integrated circuits (ASICs), field programmable gate arrays (FPGAs), etc. Non-limiting examples of commercially available computer systems include, but are not limited to, i3, i5, or i7 Core® series microprocessor from Intel Corporation, U.S.A., a SPARC T4 microprocessor from Oracle, Inc., or a ColdFire® microprocessor from Motorola Corporation. The logic processing units in the one or more control circuits 120 may include any number of cores, any number of processors, or any number of processing units. The one or more control circuits 120 communicate with each of the individually addressable pin driver circuits 106 via one or more digital buses 124. The one or more buses 124 can include a bus having any architecture (serial, parallel, or any combination thereof) and operated at any clock speed. The one or more digital buses 124 can employ any known bus structures or architectures, including a memory bus with memory controller, a peripheral bus, and a local bus.

The nontransitory storage medium 122 can include any number of components, devices, and/or systems for storing at least one or more machine executable instruction sets. The nontransitory storage medium 122 may include either or both read-only memory (“ROM”) and random access memory (“RAM”). A basic input/output system (“BIOS”), which can form part of the ROM, contains basic routines that help transfer information between elements, such as during start-up. In at least some implementations, the one or more control circuits 120 may include some or all of the nontransitory storage media. In other implementations, the nontransitory storage media 122 may include one or more discrete components or devices such as random access memory, dynamic random access memory, or the like that is communicably coupled to the one or more control circuits via one or more buses. In some instances, some or all of the nontransitory storage media 122 may include removable media such as a secure digital (“SD”) card or universal serial bus (“USB”) thumb drive.

In operation, one or more user supplied inputs, for example one or more user inputs provided via a touchscreen surface or touchscreen display (not shown in FIG. 1) cause the one or more control circuits 120 to determine a physical movement or displacement of the surface magnet 102 that corresponds to one or more aspects (pressure, direction, number of touches, relative position and/or movement of two or more touches, touch force, etc.) of the input received via the touchscreen surface or display. Such displacement may include application of a force feedback effect via the touchscreen surface or display, the application of a tactile feedback effect via the touchscreen surface or display, or any combination thereof.

To cause such a physical movement or displacement of the surface magnet 102, the one or more control circuits 120 selectively place some or all of the individually addressable pin driver circuits 106 in a respective operating mode and selectively determine and/or retrieve one or more operating parameters for the selected operating mode. The one or more control circuits 120 communicate data indicative of the selected operating mode and operating parameters to the pin driver circuit 106 via the digital bus 124 using the individual address assigned to each respective pin driver circuit 106. When received by the pin driver circuit 106, the data indicative of the operating mode and one or more operating parameters cause the communicably coupled electromagnet 104 to generate a magnetic field having a size, shape, and strength to cause the desired defined physical movement or displacement of the surface magnet 102 and provide the user with the appropriate force and/or tactile feedback effect. In some instances, such physical movement or displacement may occur in one or more directions 112 along the first axis 110.

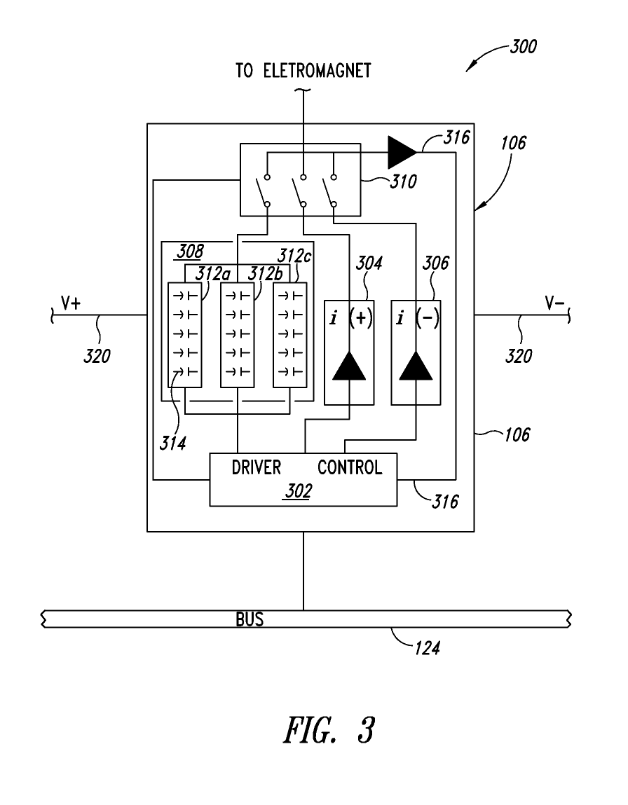

FIG. 2A shows a haptic feedback system 200 that includes a surface magnet 102, an electromagnet 104, and an electromagnet pair that includes two opposed electromagnets 202a-202b (collectively, “pair of opposed electromagnets 202”) disposed on opposite sides of the surface magnet 102. The pair of opposed electromagnets 202 cause a physical movement or displacement of the surface magnet 102 in one or more directions 212a-212b along a second axis 210. The second axis 210 can form any angle with the first axis 110. In some implementations the second axis 210 is orthogonal (i.e., at a 90° angle) to the first axis 110.

Any number of pin driver circuits 106 may be communicably coupled to each of the electromagnets 202a₁ and 202a₂ included pair of opposed electromagnets 202a. FIG. 2A shows an implementation where two pin driver circuits 106aa₁ and 106ba₁ are communicably coupled to electromagnet 202a₁ and two pin driver circuits 106aa₂ and 106ba₂ are communicably coupled to electromagnet 202a₂. Each of the pin driver circuits 106 are communicably coupled to the one or more control circuits 120 (not shown in FIGS. 2A and 2B) by the digital bus 124.

Advantageously, any number of pairs of opposed electromagnets 202 may be similarly arranged and positioned relative to the surface magnet 102. For example, FIG. 2B shows a haptic feedback system 200 that includes two pairs of opposed electromagnets 202a and 202b. Electromagnet pair 202a includes opposed electromagnets 202a₁ and 202a₂, electromagnet pair 202b includes opposed electromagnets 202b₁ and 202b₂. A number of pin driver circuits 106 may be coupled to each of the electromagnets 202a₁ and 202a₂ and 202b₁ and 202b₂ in each pair of opposed electromagnets 202. The two pairs of opposed electromagnets 202a and 202b shown in FIG. 2B are disposed along respective second axes 210a and 210b. In some instances, the two second axes 210a and 210b may be orthogonal to each other. In some instances, in addition to the second axes 210a and 210b being orthogonal to each other, both second axis 210a and second axis 210b may be orthogonal to the first axis 110 thereby forming a Cartesian space (i.e., mutually orthogonal x-, y-, and z-axes forming a three-dimensional space) in which the surface magnet 102 is moved or physically displaced by the five electromagnets 104, 202a₁, 202a₂, 202b₁ and 202b₂.

In operation, one or more user supplied inputs, for example one or more user inputs provided via a touchscreen surface or display device (not shown in FIG. 2) cause the one or more control circuits 120 to determine a physical movement or displacement of the surface magnet 102 that corresponds to one or more aspects (pressure, direction, number of touches, relative position and/or movement of two or more touches, touch force, etc.) of the input received via the touchscreen surface or display. Such physical movement or displacement may include a physical movement or displacement having one or more of: a defined displacement direction, a defined displacement rate, a defined displacement frequency, a defined displacement distance or magnitude, and/or a defined displacement time.

To cause such a displacement of the surface magnet 102, the one or more control circuits 120 selectively place some or all of the individually addressable pin driver circuits 106 to a respective operating mode and selectively determine and/or retrieve one or more operating parameters for the selected operating mode. The one or more control circuits 120 communicate data indicative of the selected operating mode and operating parameters to the pin driver circuit 106 via the digital bus 124 using the individual address assigned to each respective pin driver circuit 106. When received by the pin driver circuit 106, the data indicative of the operating mode and one or more operating parameters cause the communicably coupled electromagnet 104 to generate a magnetic field having a size, shape, and strength to cause the desired defined physical movement or displacement of the surface magnet 102 and provide the user with the appropriate force and/or tactile feedback effect. In some instances, such physical movement or displacement may occur in one or more directions 112 along the first axis 110.

The one or more control circuits 120 communicate data indicative of the selected operating mode and operating parameters to each respective individually addressable pin driver circuits 106a and 106b via the digital bus 124 using the individual addresses assigned to each respective pin driver circuit 106a, 106b. Electromagnets 104, 202a₁, 202a₂, 202b₁, and 202b₂ combine to generate a magnetic field having a size, shape, and strength sufficient to cause the desired defined physical movement or displacement of the surface magnet 102. In some instances, such physical movement or displacement may occur in one or more directions 112 along the first axis 110, in one or more directions 212a along axis 210a, in one or more directions 212b along axis 210b, or any combination thereof.

FIG. 3 shows a schematic 300 of an illustrative pin driver circuit 106, according to one or more illustrated embodiments. Each pin driver circuit 106 can include but is not limited to at least one driver control circuit 302 that is communicably coupled to a number of switchable driver elements, each corresponding to an operation mode, that are communicably coupled to switch 310 controlled by the at least one driver control circuit 302. The switchable driver elements include, but are not limited to, a current sourcing driver 304, a current sinking driver 306, and a switched capacitor network 308 that includes a number of individually addressable switchable capacitor banks 312a-312c (collectively, “switchable capacitor banks 312”) each of which includes equal or unequal numbers of capacitive elements 314. Each of the capacitive elements 314 in each of the switchable capacitor banks 312 may have equal or unequal capacitance values. In at least some implementations, the capacitive elements 314 in each switchable capacitor bank 312 are addressable singly or in groups. A closed loop feedback circuit 316 communicably couples the electromagnet to the driver control circuit 302. In at least some implementations, one or more measured or inferred feedback parameters associated with the electromagnet may be communicated to the control circuit 120 via the digital bus 124.

The one or more control circuits 120 select the operating mode for each of the pin driver circuits 106 in the haptic feedback system 100, 200. In at least some instances, the operating mode includes at least one of: a current sourcing operating mode, a current sinking operating mode, or a switched capacitor operating mode. In addition, the one or more control circuits 120 select one or more operating parameters to control one or more aspects of the output from each respective pin driver circuit 106 to the communicably coupled electromagnet(s) 104 and/or 202. The selected operating mode and selected operating parameters are communicated by the one or more control circuits 120 to the respective pin driver circuit 106 via the digital bus 124. Since each pin driver circuit 106 is individually addressable, different operating modes and/or operating parameters may be advantageously communicated to some or all of the pin driver circuits 106 in the haptic feedback system 100, 200. The ability to individually control the pin driver circuits 106 provides operational flexibility and permits the physical displacement of the surface magnet 102 to provide virtually any motion, movement, or texture on a haptic feedback device such as a touchscreen physically coupled to the surface magnet 102.

The operating mode and operating parameter information is received at the pin driver circuit 106 via the digital bus 124 by the at least one driver control circuit 302. Responsive to the receipt of operating mode information from the one or more control circuits 120, the driver control circuit 302 selectively positions the switch 310 to couple the appropriate switchable driver element to the electromagnet (e.g., electromagnets 104, 202a₁, 202a₂, 202b₁ and/or 202b₂) communicably coupled to the pin driver circuit 106. Responsive to the receipt of operating parameter information from the one or more control circuits 120, the driver control circuit 302 selectively adjusts one or more switchable element parameters.

Advantageously, since each pin driver circuit 106 is individually addressable and controllable by the one or more control circuits 120, the one or more control circuits 120 are able to selectively cause the pin driver circuits 106 to enter any operating mode, in any fixed or variable sequence, over any fixed or variable time interval, and with any fixed or variable operating parameters. Such a large degree of operational flexibility permits the one or more control circuits 120 to create an extremely large number of potential outputs for each pin driver circuit 106, thereby providing an extremely large number of haptic feedback effects to a user of the haptic feedback system 100, 200.

Thus, for example, the one or more control circuits 120 may generate an instruction containing information that when received by the pin driver circuit 106 causes the driver control circuit 302 to place the switch 310 in a position corresponding to a defined first operating mode, such as a current sourcing mode in which the pin driver circuit 106 permits current to flow in a first direction through a coil or winding in the electromagnet communicably coupled to the pin driver circuit 106. In such an instance, the one or more control circuits 120 may generate an instruction containing information indicative of operating parameters such as current value (e.g., 0.1 milliamps) and/or a duration (e.g., 2 seconds). Thus, the driver control circuit 302 will position the switch 310 to place the current sourcing driver (i.e. first operating mode) in line with the communicably coupled electromagnet. The control circuit 302 will then pass a current of 0.1 mA through the coil or winding of the communicably coupled electromagnet in the first direction for a duration of 2 seconds.

In some instances, such as the example described above, the one or more control circuits 120 provide operating parameters that cause the pin driver circuit 106 to cease driving the communicably coupled electromagnet after a defined interval, duration, or event. In other instances, the one or more control circuits 120 may communicate a first instruction that includes operating mode and parameter information sufficient to cause the pin driver circuit 106 to provide a defined output to the communicably coupled electromagnet until an END instruction is received. After an interval or duration, measured for example using a counter or timer resident in or coupled to the one or more control circuits 120, the one or more control circuits 120 may communicate a second instruction that includes the END instruction to terminate the provision of the defined output to the communicably coupled electromagnet.

In another example, the one or more control circuits 120 may generate an instruction containing information that when received by the pin driver circuit 106 causes the driver control circuit 302 to place the switch 310 in a position corresponding to a defined second operating mode, such as a current sinking mode in which the pin driver circuit 106 permits current to flow in a second direction through a coil or winding in the electromagnet communicably coupled to the pin driver circuit 106. In such an instance, the one or more control circuits 120 may generate an instruction containing information indicative of operating parameters such as current value (e.g., 0.1 milliamps) and/or a duration (e.g., 2 seconds). Thus, the driver control circuit 302 will position the switch 310 to place the current sinking driver (i.e. the second operating mode) in line with the communicably coupled electromagnet. The control circuit 302 will then pass a current of 0.1 mA through the coil or winding of the communicably coupled electromagnet in the second direction for a duration of 2 seconds.

In yet another example, the one or more control circuits 120 may generate an instruction containing information that when received by the pin driver circuit 106 causes the driver control circuit 302 to place the switch 310 in a position corresponding to a defined third operating mode, such as a switched capacitor mode in which the pin driver circuit 106 selectively permits some or all of the switched capacitor banks 312 to charge and selectively permits some or all of the switched capacitor banks 312 to discharge through a coil or winding in the electromagnet communicably coupled to the pin driver circuit 106. The charging and discharging sequence is determined by the one or more control circuits 120. Thus, where a pin driver circuit 106 includes four switchable banks of capacitors 312 (e.g., banks A, B, C, and D), with each bank including ten (10) individually addressable 47 μF capacitive elements (e.g. C1-C10). The one or more controllers 120 may communicate to the driver control circuit 302 operating parameter instructions such as:

1. Charge banks A, B, C, D

2. Discharge bank A (470 μF)

3. After 0.1 sec, switch to Bank B, charge bank A (C1-C10)

4. Discharge bank B, C1-C5 (235 μF)

5. After 0.2 sec, discharge bank B C6-C10 (235 μF)

6. After 0.2 sec switch to bank C, charge bank B (C1-C10)

7. Discharge bank C (470 μF)

8. After 0.1 sec, switch to Bank D, charge bank C (C1-C10)

9. Discharge bank D, C1-C3 (141 μF)

10. After 0.2 sec, discharge bank D C4-C10 (329 μF)

11. After 0.2 sec switch to bank A, charge bank D (C1-C10).

Although provided as an illustrative example, one of skill in the art can appreciate the large number of operating parameter combinations possible and the consequent large number of haptic feedback textures possible using the haptic feedback system 100, 200.

The at least one driver control circuit 302 can include any circuit, component, device, or combination of circuits, components, and/or systems capable of executing one or more machine executable instruction sets to control the operation of the one or more switches 310 and the switchable driver elements 340, 306, and 308. The at least one driver control circuit 302 may include one or more logic processing units, such as one or more central processing units (“CPUs”), microprocessor, systems on a chip (“SOC”) digital signal processors (“DSPs”), application-specific integrated circuits (“ASICs”), field programmable gate arrays (“FPGAs”), etc. Non-limiting examples of commercially available microprocessors include, but are not limited to, i3, i5, or i7 Core® series microprocessor from Intel Corporation, U.S.A., a SPARC T4 microprocessor from Oracle, Inc., or a ColdFire® microprocessor from Motorola Corporation. The logic processing units in the at least one driver control circuit 302 may include any number of cores, any number of processors, or any number of processing units.

The current sourcing driver 304 can include any circuit, component, device, system, or combinations thereof capable of providing a stable current output flowing in a first direction through a communicably coupled electromagnet. Similarly, the current sinking driver 306 can include any circuit, component, device, system, or combinations thereof capable of providing a stable current output flowing in a second direction through a communicably coupled electromagnet.

The switched capacitor network 308 includes any number of capacitor banks 312a-312c. Each of the number of switched capacitor banks 312 include one or more switching devices that enable the respective switched capacitor bank 312 to charge and/or discharge either individually or in concert with any number of the other switched capacitor banks 312. Thus, switched capacitor bank 312a may charge and discharge individually or may charge and discharge in concert with switched capacitor banks 312b and/or 312c. The switching devices that couple each of the respective switched capacitor banks 312 to the voltage source for charging and to the switch 310 for discharging are controlled by the at least one driver control circuit 302 and can include any type of mechanical, electrical, electromechanical, or semiconductor switching device.

Each of the switched capacitor banks 312 can include a similar or different number of capacitors or capacitive elements 314. For example, in one implementation, a switched capacitor network 308 that includes four (4) switched capacitor banks 312a-312d may have ten (10) 47 μF capacitive elements in each of the switched capacitor banks 312a-312d. In another implementation a switched capacitor network 308 that includes four (4) switched capacitor banks 312a-312d may have ten (10) 47 μF capacitive elements in switched capacitor banks 312a and 312c and five (5) 68 μF capacitive elements in switched capacitor banks 312b and 312d. In some implementations, for example in implementations having individually addressable capacitive elements, the capacitance of each of the capacitive elements 314 in each bank may be the same or different.

At times, the at least one driver control circuit 302 will supply power (e.g., +24 VDC power) to simultaneously charge all of the capacitive elements 314 in one or more switched capacitor banks 312. Similarly, at times, the at least one driver control circuit 302 will simultaneously discharge all of the capacitive elements 314 in one or more switched capacitor banks 312. Operating parameters such as the charge carried by the capacitors, the discharge frequency, and the timing of the discharge with respect to the magnetic fields produced by electromagnets coupled to other pin driver circuits 106 determine the physical displacement or movement of the surface magnet 102. In such an instance, the one or more controllers 120 may communicate to the driver control circuit 302 operating parameter instructions such as:

1. Charge banks A, B, C, D

2. Discharge banks A and B

3. After 0.1 sec, switch to Bank C, charge banks A and B

4. Discharge bank C

5. After 0.2 sec switch to bank D, charge bank C (C1-C10)

6. Discharge bank D

7. After 0.3 sec, switch to banks A and B, charge bank D.

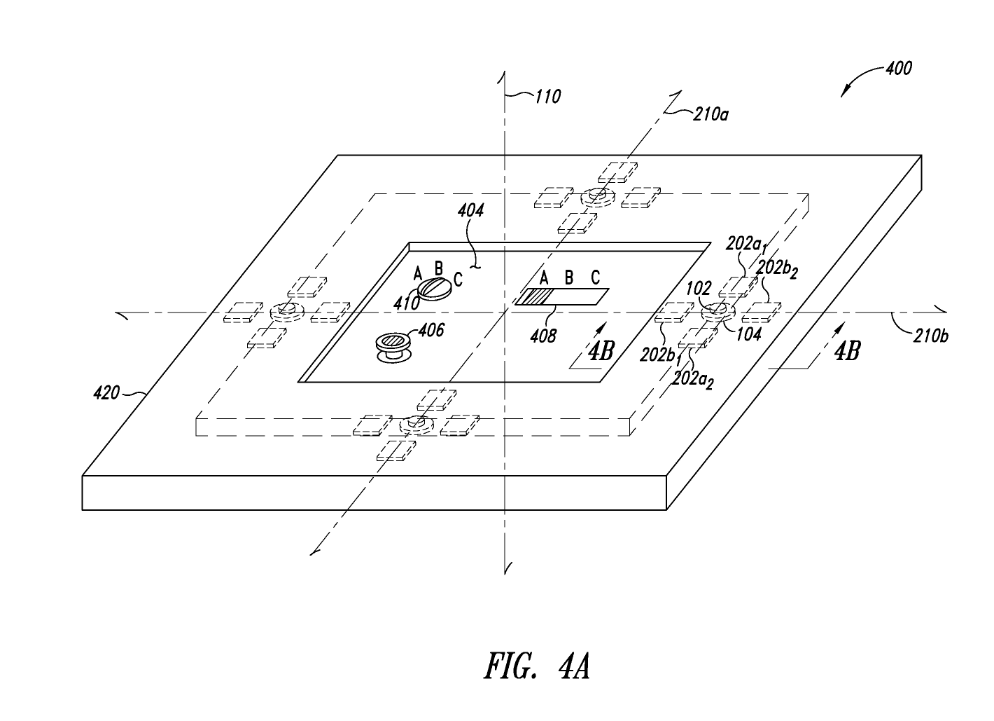

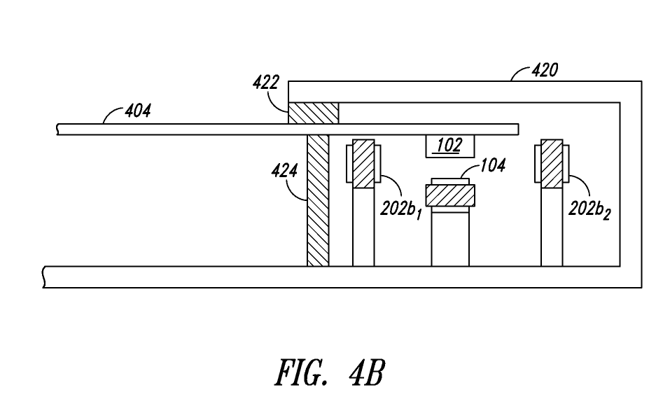

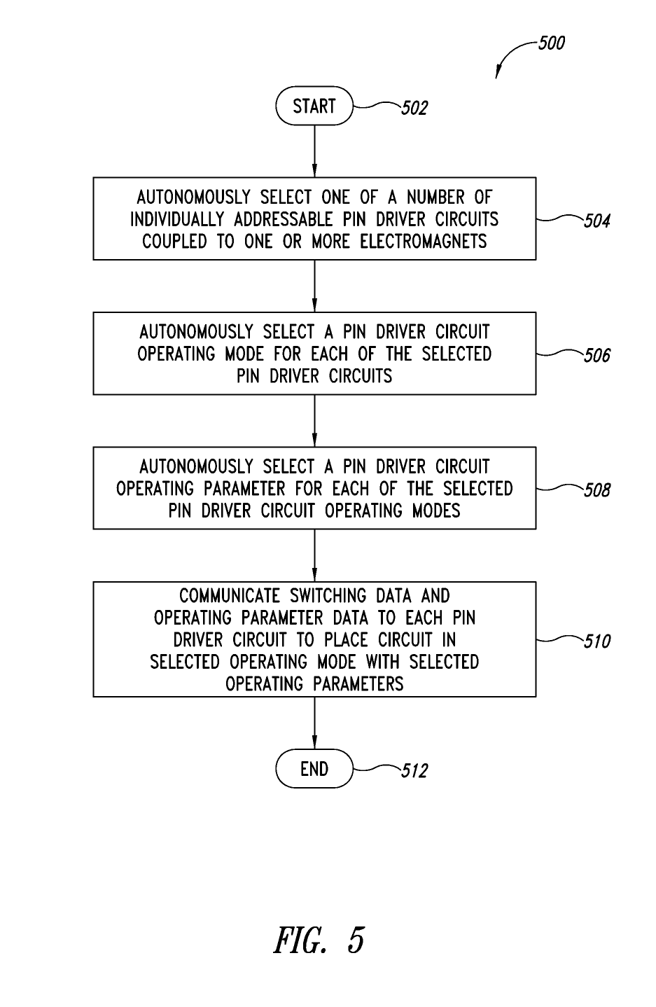

FIG. 4A shows a touchscreen haptic interface system 400 that includes a number of surface magnets 102 physically coupled to the touchscreen surface 404 at various points disposed about a periphery of the touchscreen surface 404 that is housed at least partially within a bezel 420 or similar structure, according to one illustrated embodiment. FIG. 4B shows a sectional elevation view through the touchscreen surface 404 and the bezel 420 that reveals driver electromagnets 104, 202b₁ and 202b₂, as well as suspension system elements 422 and 424 that flexibly couple the touchscreen surface 404 to the bezel 420 while permitting the physical movement or displacement of the touchscreen surface 404 within the bezel 420 along one or more axes 110, 201a, and/or 210b.

Although four (4) surface magnets 102 and four (4) sets of driver electromagnets 104, 202a, and 202b are shown disposed about the periphery of the touchscreen surface 404 in FIG. 4A, any greater or lesser number of surface magnets 102 may be disposed at locations on the touchscreen surface 404. For example, where the touchscreen surface 404 is opaque, one or more surface magnets 102 may be coupled to the touchscreen surface 404 in a central location. Additionally, while each of the surface magnets 102 is depicted in FIG. 4A along with a respective electromagnet 104 to physically displace the surface magnet in one or more directions along axis 110 and two pairs of electromagnets 202a and 202b are depicted in FIG. 4A to physically displace the surface magnet in one or more directions along axes 210a and 210b, respectively, any number or combination of driver electromagnets 104, 202a, 202b may be used to physically displace each of the respective surface magnets 102.

The surface magnet 102 is physically displaceable in a direction along axis 110 that is normal to the touchscreen surface 404 using an electromagnet 104 such as that illustrated and described in detail with regard to FIG. 1. The surface magnet 102 is physically displaceable in a direction along a second axis 210a using a first pair 202a of opposed electromagnets 202a₁ and 202a₂ such as that illustrated and described in detail with regard to FIG. 2. The second axis 210a is parallel to the plane formed by the touchscreen surface 404 and orthogonal to the first axis 110. The surface magnet 102 is physically displaceable in a direction along a second axis 210b using a second pair 202b of opposed electromagnets 202b₁ and 202b₂ such as that illustrated and described in detail with regard to FIG. 2. The second axis 210b is also parallel to the plane formed by the touchscreen surface 404 and orthogonal to both the first axis 110 and the second axis 210a. Thus the combined magnetic fields produced electromagnet 104 and the electromagnet pairs 202a and 202b are able to provide a physical displacement of the surface magnet 102 (and the physically coupled touchscreen surface 404) in a three-dimensional space.

While illustrated as a touchscreen haptic interface system 400 including a touchscreen surface 404, in some implementations the teachings herein may be applied to other touch sensitive or touch responsive devices equipped with any type or style of touch sensitive or touchscreen surface 404, capable of displaying, representing, simulating, and/or providing a functional replacement for one or more physical electrical, electromechanical, or mechanical devices such as: a pushbutton 406, a slider switch 408, and/or a rotary selector switch 410. The user-actuatable devices are shown as representative devices and not as an exhaustive list of such devices. Other devices and user interface elements such as icons, user input devices such as wheels, slides, trackpads, pointing devices, virtual keyboards, and similar may also employ the haptic drive mechanism techniques described herein.

In some instances, the touchscreen surface 404 can include one or more transparent, translucent, or opaque single or multi-touch surfaces capable of generating one or more machine readable signals indicative of input parametric data such as: a tactile input location, a tactile input direction, a tactile input motion, a tactile input force, a geometric relationship between multiple tactile inputs, or combinations thereof. Any or all of the parametric data may be used to generate an appropriate tactile or force feedback response via the touchscreen surface 404. The touchscreen surface 404 can employ one or more touch sensors including, but not limited to: projected capacitive touch technology, force-sensing resistive touch technology, capacitive touch sensing technology, resistive touch sensing technology, optical touch sensing technology, pressure sensing touch sensitive technology, or any combination thereof.

The touchscreen surface 404 is flexibly or displaceably coupled to the bezel 420 using one or more suspension elements 422, 424. The suspension elements 422, 424 permit the physical movement of the touchscreen surface 404 relative to the fixed bezel 420. Such permits the touchscreen surface to advantageously provide a wide variety of tactile and/or force feedback including physical displacement in one or more directions along one or more axes 110, 210a, and 210b. The suspension elements can include any number of devices, components, systems, or combinations thereof that are suitable for flexibly coupling in any number of locations the touchscreen surface 404 to the bezel 420. In some instances, some or all of the suspension elements 422, 424 may include one or more elastomeric or similarly pliable homogenous or non-homogeneous materials. In some instances, some or all of the suspension elements 422, 424 may include mechanical elements such as coil springs, leaf springs, compression springs, bellows, flexures, and the like. In some instances, some or all of the suspension elements 422, 424 may include one or more electronic or electromagnetic suspension elements. In some implementations, some or all of the spring elements 422, 424 may have one or more variable, adjustable or controllable parameters affecting the damping of the various elements 422, 424 flexibly coupling the touchscreen surface 404 to the bezel 420.

In the touchscreen haptic interface system 400, the surface magnet 102 is coupled to the touchscreen surface 404 to provide user feedback via physical displacement of the touchscreen surface 404. In some instances, the haptic feedback system 200 may be communicably coupled to a microprocessor, graphical processing unit (“GPU”), or similar processing and/or computing device and/or circuit responsible for causing the display of the user-actuatable elements (i.e., 406, 408, 410) on a touchscreen display that provides all or a portion of the touchscreen surface 404.

In some instances, the one or more control devices 120 accesses, looks-up, or retrieves from the nontransitory storage media 122 operating modes and/or operating parameters for each pin driver circuit 106. The retrieved operating modes and/or operating parameters are used by the one or more control devices 120 to generate instructions for communication to some or all of the pin driver circuits 106. The instructions communicated to the pin driver circuits 106 cause the touchscreen haptic interface system 400 to provide a haptic feedback effect logically associated with a particular user touch or user actuation of one or more displayed devices.

Combining the wide variety of haptic feedback offered by the haptic feedback system 100, 200 with the touchscreen surface 404 advantageously enables the provision of haptic or tactile feedback to a user that simulates the physical movement, activation, texture or action of the displayed user-actuatable device. For example, the touchscreen surface 404 may provide a user-actuatable control such as a pushbutton 406 used to start and stop a production process. When the haptic feedback system 200 receives an input corresponding to a user contacting the touchscreen surface 404, the haptic feedback system 200 may cause a continuous or semi-continuous vibration of the touchscreen surface 404 along the first axis 110 using the electromagnet 104 to provide haptic feedback to the user as representative of the vibration produced by a running process. When the haptic feedback system 200 receives an input corresponding to a user actuating the displayed pushbutton 406 to STOP the process, the haptic feedback system 200 may cause a momentary downward physical displacement of the touchscreen surface 404 along the first axis 110 using the electromagnet 104, a delay where the touchscreen surface is held in a lowered position by the electromagnet 104, followed by a return to the original touchscreen surface 404 position to provide haptic feedback to the user that simulates the downward and return movement of the virtual pushbutton 406. Additionally, after actuating the STOP pushbutton 406, after the touchscreen surface 404 returns to the original position, the haptic feedback system 202 may cause the touchscreen surface 404 to remain stationary (i.e., not vibrate) as representative of the stillness produced by a stopped process.

In another example, a virtual representation of a slider control 408 may be displayed on the touchscreen surface 404. Responsive to a user input indicative of a desire to slide the slider control in a first direction (e.g., to the left) the haptic feedback system 200 may cause a momentary leftward physical displacement of the touchscreen surface 404 along the second axis 210b using the second pair 202b of opposed electromagnets 202b₁ and 202b₂, a delay where the touchscreen surface is momentarily held in a left-displaced position by the second pair 202b of opposed electromagnets 202b₁ and 202b₂, followed by a return to the original touchscreen surface 404 position to provide haptic feedback to the user that simulates the leftward physical movement of the virtual slider control 408.

In yet another example, a virtual representation of a rotary selector switch 410 may be displayed on the touchscreen surface 404. Responsive to a user input indicative of a desire to rotate the displayed rotary selector switch 410 in a first direction (e.g., to the right), the haptic feedback system 200 may cause a momentary radial displacement of the touchscreen surface 404 along the second axes 201a and 210b using the first pair 202a of opposed electromagnets 202a₁ and 202a₂ and the second pair 202b of opposed electromagnets 202b₁ and 202b₂ to produce a magnetic field that causes the surface magnet 102 to physically displace through an arc corresponding to the arc followed by the rotary selector switch 410. The haptic feedback system 200 may further cause a delay where the touchscreen surface is momentarily held in a displaced location by the first pair 202a of opposed electromagnets 202a₁ and 202a₂ and the second pair 202b of opposed electromagnets 202b₁ and 202b₂, followed by a return to the original touchscreen surface 404 position. Although provided as illustrative examples, one can appreciate that the three-dimensional displacement achievable using the electromagnet 104 and one or more pairs of opposed electromagnets 202 when coupled with the flexible output provided by the pin driver circuits 106, virtually any haptic feedback effect can be produced by the haptic feedback system 200.

In some instances, the touchscreen haptic interface system 400 depicted in FIGS. 4A and 4B may be communicably coupled to one or more external feedback devices. In such implementations, the haptic feedback provided by the touchscreen haptic interface system 400 may be accompanied by contemporaneous or near-contemporaneous feedback provided to a system user via the external feedback device. For example, a user in a noisy environment may wear an external feedback device such as a noise reduction/protective helmet that is tethered or wirelessly coupled to the touchscreen haptic interface system 400 to provide audio feedback (e.g., via one or more speakers) and visual feedback (e.g., via a heads-up display projected on a visor). In such an instance, a tactile input on the touchscreen surface 404 (e.g., depressing a pushbutton control) may cause the touchscreen haptic interface system 400 to provide tactile feedback simulating the physical action of a pushbutton and communicate one or more audio signals simulating the “click/click” sound of a mechanical pushbutton to the external feedback device. In addition, the touchscreen haptic interface system 400 may communicate one or more video or image signals depicting a simulated pushbutton actuation on a heads-up display coupled to the external feedback device.

FIG. 5 provides a high-level method 500 for an example haptic feedback system. Each pin driver circuit 106 may be placed in one of any number of operating modes. One or more operating parameters may be used to alter, adjust, or control one or more aspects of each operating mode. In at least some implementations, one or more user inputs received by the one or more control circuits 120 cause the one or more control circuits 120 to determine operating modes and/or operating parameters for some or all of the pin driver circuits 106 included in the haptic feedback system. In some instances, the one or more control circuits 120 may retrieve from the nontransitory storage media 122 data indicative of an operating mode and/or operating parameters logically associated with the one or more received user input. The method 500 for controlling a number of pin driver circuits in a haptic feedback system commences at 502.

At 504, the control circuit 120 autonomously selects at least one of a number of individually addressable pin driver circuits 106 to achieve a defined tactile and/or force feedback effect via the touchscreen surface 404. In at least some implementations, the control circuit 120 selects the pin driver circuits 106 based at least in part on one or more aspects of a received user input, for example, a force feedback effect may be provided in one or more directions opposite the sensed direction of a user input. In another example, tactile feedback in the form of a texture simulating the roughness of a surface on a user selected portion of an object may be provided by the control circuit 120 autonomously selecting the pin driver circuits 106 needed to achieve the desired tactile feedback effect on the touchscreen surface 404.

At 506, the control circuit 120 autonomously selects one or more operating modes for each of the pin driver circuits 106 selected by the control circuit 120 at 504. In at least some implementations, the control circuit 120 selects the pin driver circuit operating mode based at least in part on one or more aspects of the received user input. For example, the control circuit 120 may autonomously select a current sinking or a current sourcing operating mode capable of generating a force feedback that simulates the actuation of a mechanical pushbutton. In another example, the control circuit 120 may autonomously select a switched capacitor mode capable of generating a vibratory output to provide tactile haptic feedback simulating the roughness of a surface on a user selected portion of an object. In some implementations, the control circuit 120 autonomously forms a logical association between the data indicative of the selected operating mode and the address identifying the respective pin driver circuit 106.

At 508, the control circuit 120 autonomously determines one or more operating parameters for each of the pin driver circuits 106 selected at 504 based at least in part on the operating mode selected for the respective pin driver circuit at 506. In at least some implementations, the control circuit 120 determines the pin driver circuit operating parameters based at least in part on one or more aspects of the received user input. For example, the control circuit 120 may autonomously select a first current sinking or current sourcing mode operating parameter corresponding to a first current level for a first defined time period to simulate the force needed to initially actuate a pushbutton, followed by a second current level for a second defined time period to simulate the reduce force needed to complete actuation of the pushbutton. In another example, the control circuit 120 may autonomously select one or more first switched capacitor mode operating parameter sets to cause the generation of small amplitude, high frequency vibrations simulating the smooth texture of silk on the touchscreen surface 404 when a user selects a first portion of an object. The control circuit 120 may alternatively autonomously select one or more second switched capacitor mode operating parameter sets that cause the generation of large amplitude, low frequency vibrations simulating the rough texture of 20-grit sandpaper on the touchscreen surface 404 responsive to a user providing an input indicative of a second portion of the object. In some implementations, the control circuit 120 forms a logical association between the data indicative of the determined operating parameters and the address identifying the respective pin driver circuit 106.

At 510, the control circuit 120 communicates data or information indicative of the selected operating mode and the determined operating parameters logically associated with a particular pin driver circuit address to the respective pin driver circuit 106. Upon receipt by the respective pin driver circuit 106, the driver control circuit 302 places the pin driver circuit 106 in the selected operating mode and establishes the pin driver circuit output to the communicably coupled electromagnet using the determined pin driver circuit parameters. The method 500 for controlling a number of pin driver circuits in a haptic feedback system concludes at 502.

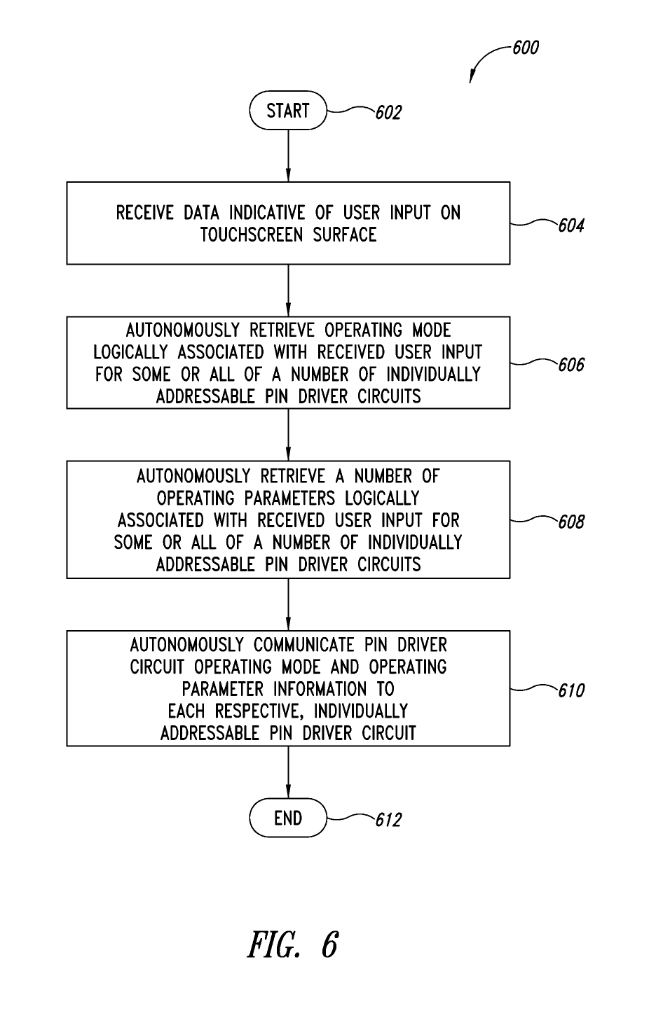

FIG. 6 shows a high-level method 600 for an example haptic feedback system based on user input provided to a touchscreen device, according to one implementation. In at least some implementations, the surface magnet 102 in haptic feedback systems 100 and/or 200 may be operably and/or physically coupled to a touchscreen surface 404 to provide haptic or tactile feedback to the touchscreen user. In such instances, the haptic feedback provided by the haptic feedback system 100 and/or 200 via the touchscreen surface 404 may be based in whole or in part on one or more aspects of the user input received via the touchscreen surface 404. For example, a user input indicative of a “sliding action” coplanar with the surface of the touchscreen may cause the haptic feedback system 200 to provide a lateral movement of the touchscreen surface 404. A user input indicative of a “pushing” action normal to the surface of the touchscreen may cause the haptic feedback system 100 to provide a vertical movement of the touchscreen surface 404. In some instances, the force applied by the user may cause the haptic feedback system to provide a correspondingly greater or lesser feedback effect (i.e., greater user force results in greater haptic feedback, and vice-versa). In at least some instances, the haptic feedback system 100 and/or 200 may store data indicative of operating mode and/or operating parameters in the nontransitory storage medium 122. Responsive to receiving a signal indicative of a particular user input on the touch screen, the control circuit 120 can retrieve or look-up the operating mode and operating parameters logically associated with the input received from the user via the touchscreen surface 404. The method 600 for controlling a number of pin driver circuits in a haptic feedback system commences at 602.

At 604, the control circuit 120 receives at least one signal or communication that includes data or information indicative of a user input provided via the touchscreen surface 404. Such data or information may include data or information indicative of a user pressing a virtual pushbutton, the force applied by the user to the virtual pushbutton icon on the touchscreen display, the direction of the force applied by the user, and the duration of the force applied by the user.

At 606, using some or all of the data or information indicative of the user input provided to the touchscreen surface 404, the control circuit 120 autonomously retrieves from the nontransitory storage medium 122 an operating mode for some or all of the pin driver circuits 106 in the haptic feedback system 100, 200. In some implementations, one or more data stores, data tables, databases or other data structures may store data indicative of logical associations between various user inputs and pin driver circuit operating modes (e.g., user input representative of depressing a simulated pushbutton may be logically associated with current sinking driver operating mode in a database or data store). In at least some implementations, such data stores, data tables, databases or other data structures may be stored or otherwise retained in the nontransitory storage medium 122 such as read only memory, random access memory, EEPROM or flash memory. In at least some instances, the retrieved operating mode is logically associated with one or more aspects of the user input received at 604 via the touchscreen surface 404. In some implementations, the control circuit 120 forms a logical association between the data indicative of the selected operating mode and the address identifying the respective pin driver circuit 106.

At 608, using some or all of the data or information indicative of the user input provided to the touchscreen surface 404, the control circuit 120 autonomously retrieves from the nontransitory storage medium 122 and/or algorithmically determines one or more operating parameters for some or all of the pin driver circuits 106 in the haptic feedback system 100, 200. In some instances, some or all of the operating parameters may be determined based on one or more aspects of the user input received at 604 via the touchscreen surface 404. In some implementations, the control circuit 120 forms a logical association between the address identifying a pin driver circuit 106, the data indicative of the operating mode for the respective pin driver circuit 106 retrieved at 604, and the data indicative of the determined operating parameters for the respective pin driver circuit 106.

At times, some or all of the operating parameters for some or all of the pin driver circuits 106 may be autonomously retrieved by the control circuit 120 from one or more data tables, databases or other data structures based on one or more aspects of the user input received at 604 via the touchscreen surface 404. For example, data indicative of one or more operating parameters may be retrieved from one or more data stores, data tables, databases or other data structures. Such data stores, data tables, databases or other data structures can store data indicative of logical associations between various user input parameters (e.g., virtual element actuated by user, applied force, applied direction, etc.), the pin driver circuit operating mode(s) logically associated with the received user input parameters, and one or more pin driver circuit operating parameters. For example, responsive to user actuation of a virtual pushbutton displayed on the display surface 404, the control circuit 120 may retrieve data indicative of a current sinking driver operating mode and operating parameters of 0.1 mA for 0.25 seconds that are logically associated with depressing a virtual pushbutton and stored in one or more data stores, data tables, databases or other data structures.

At times, some or all of the operating parameters for some or all of the pin driver circuits 106 may be autonomously algorithmically determined by the control circuit 120. In at least some instances, one or more operating parameters may be determined at least in part using one or more aspects of the user input received at 604 via the touchscreen surface 404. For example, the signal received by the control circuit 120 may include data indicative of the force applied by the user to the touchscreen surface 404 and the control circuit 120 may autonomously algorithmically determine one or more parameters, such as the physical displacement of the touchscreen surface 404 based on the force applied by the user.

At 610, the control circuit 120 autonomously communicates data or information indicative of the selected operating mode retrieved at 606, and data indicative of the operating parameters determined and/or retrieved at 608 to the respective pin driver circuit 106. Upon receipt by the respective pin driver circuit 106, the driver control circuit 302 places the pin driver circuit 106 in the selected operating mode and establishes the pin driver circuit output to the communicably coupled electromagnet using the determined pin driver circuit parameters. The method 600 for controlling a number of pin driver circuits in a haptic feedback system concludes at 602.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other environments, not necessarily the exemplary commercial environment generally described above.

Also for instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms of taught herein are capable of being distributed as a program product in a variety of forms, and that an illustrative embodiment applies equally regardless of the particular type of physical signal bearing media used to actually carry out the distribution. Examples of physical signal bearing media include, but are not limited to, the following: recordable type media such as floppy disks, hard disk drives, CD ROMs, digital tape, and computer memory.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet, including but not limited to: U.S. Provisional Patent Application Ser. No. 61/722,649, filed Nov. 5, 2012 are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A haptic interface system, the system comprising:
at least one surface magnet; and
a haptic interface driver subsystem including:
an electromagnet to cause physical movement of the surface magnet in one or more defined directions along a first axis; and
at least one individually addressable pin driver circuit operably coupled to the electromagnet, the individually addressable pin driver circuit selectively switchable into one of a number of operating modes each of which causes a different physical movement of the surface magnet along the first axis;
at least one digital control bus communicably coupled to the at least one individually addressable pin driver circuit
at least one controller communicably coupled to the digital control bus, the at least one controller to individually address and selectively switch each of the individually addressable pin driver circuits into one of the number of operating modes.

2. The haptic interface system of claim 1, further comprising:
machine executable instructions stored in at least one nontransitory storage medium communicably coupled to the at least one controller, that when executed by the at least one controller cause the at least one controller to:
for each of the pin driver circuits:
select a pin driver circuit operating mode from the number of operating modes;
determine one or more pin driver circuit operating parameters to cause the physical movement of the surface magnet in the one or more defined directions along the first axis at: a defined frequency, a defined amplitude, or both a defined frequency and a defined amplitude;
logically associate the determined one or more pin driver circuit operating parameters with the selected pin driver circuit operating mode; and
communicate the selected pin driver circuit operating mode and the logically associated determined one or more pin driver circuit operating parameters to the respective pin driver circuit via the digital control bus.

3. The haptic interface system of claim 2, wherein the machine executable instructions further cause the at least one controller to:
autonomously select a pin driver circuit operating mode from the number of operating modes; and
autonomously determine one or more pin driver circuit operating parameters to cause the physical movement of the surface magnet in the one or more defined directions along the first axis.

4. The haptic interface system of claim 3, further comprising
a touchscreen display device operably coupled to the surface magnet, that at times during operation displays representations of one or more human-actuatable devices, each of the displayed human-actuatable devices having stored in the at least one nontransitory storage medium at least one logically associated physical movement.

5. The haptic interface system of claim 4, wherein the machine executable instructions that cause the at least one controller to select a pin driver circuit operating mode from the number of operating modes further cause the at least one controller to:
detect a human actuation of a device displayed on the touchscreen display device;
autonomously determine the at least one physical movement logically associated with the detected human-actuated device;
autonomously select a pin driver circuit operating mode from the number of operating modes sufficient to cause the at least one physical movement logically associated with the detected human-actuated device; and
autonomously determine one or more pin driver circuit operating parameters sufficient to cause the at least one physical movement logically associated with the detected human-actuated device.

6. The haptic interface system of claim 3, wherein the haptic interface driver subsystem further comprises:
a number of pairs of opposed electromagnets, each of the pairs of opposed electromagnets to cause physical movement of the surface magnet in one or more defined directions along a respective second axis, the second axis orthogonal to the first axis;
at least one individually addressable pin driver circuit operably coupled to each electromagnet in each pair of opposed electromagnets, the individually addressable pin driver circuit selectively switchable into one of a number of operating modes each of which causes a different physical movement of the surface magnet along the respective second axis; and
wherein the at least one controller individually addresses and selectively switches each of the pin driver circuits into one of the number of operating modes.

7. The haptic interface system of claim 6, further comprising:
machine executable instructions stored in at least one nontransitory storage medium communicably coupled to the at least one controller, that when executed by the at least one controller cause the at least one controller to:
for each of the pin driver circuits operably coupled to each pair of opposed electromagnets:
select a pin driver circuit operating mode from the number of operating modes;
determine one or more pin driver circuit operating parameters to cause the physical movement of the surface magnet in the one or more defined directions along the respective second axis at: a defined frequency, a defined amplitude, or both a defined frequency and a defined amplitude;
logically associate the determined one or more pin driver circuit operating parameters with the selected pin driver circuit operating mode; and
communicate the selected pin driver circuit operating mode and the logically associated determined one or more pin driver circuit operating parameters to the respective pin driver circuit via the digital control bus.

8. The haptic interface system of claim 7, wherein the machine executable instructions further cause the at least one controller to:
autonomously select a pin driver circuit operating mode from the number of operating modes; and
autonomously determine one or more pin driver circuit operating parameters to cause the physical movement of the surface magnet in the one or more defined directions along the second axis.

9. The haptic interface system of claim 8, further comprising
a touchscreen display device operably coupled to the surface magnet, that at times when in operation displays representations of one or more human-actuatable devices, each of the displayed human-actuatable devices having stored in the at least one nontransitory storage medium at least one logically associated physical movement.

10. The haptic interface system of claim 9, wherein the machine executable instructions that cause the at least one controller to select a pin driver circuit operating modes for the electromagnet and for the electromagnets in each pair of opposed electromagnets further cause the at least one controller to:
detect a human actuation of a device displayed on the touchscreen display device;
autonomously determine the at least one physical movement logically associated with the detected human-actuated device;
for each of the pin driver circuits operably coupled to the electromagnet, autonomously select a pin driver circuit operating mode from the number of operating modes sufficient to cause the at least one physical movement along the first axis logically associated with the detected human-actuated device;
for each of the pin driver circuits operably coupled to the electromagnet, autonomously determine one or more pin driver circuit operating parameters sufficient to cause the at least one physical movement along the first axis logically associated with the detected human-actuated device;
for each of the pin driver circuits operably coupled to the electromagnets in each pair of opposed electromagnets, autonomously select a pin driver circuit operating mode from the number of operating modes sufficient to cause the at least one physical movement along each respective second axis logically associated with the detected human-actuated device; and
for each of the pin driver circuits operably coupled to the electromagnets in each pair of opposed electromagnets, autonomously determine one or more pin driver circuit operating parameters sufficient to cause the at least one physical movement along each respective second axis logically associated with the detected human-actuated device.

11. The haptic interface system of claim 1 wherein the surface magnet comprises an electromagnet.

12. The haptic feedback system of claim 11 wherein the haptic interface driver subsystem further comprises:
at least one individually addressable surface pin driver circuit operably coupled to the surface electromagnet, the individually addressable surface pin driver circuit selectively switchable into one of a number of operating modes; and
wherein the at least one controller individually addresses and selectively switches the surface pin driver circuit into one of the number of operating modes.

13. The haptic feedback system of claim 1 wherein the at least one individually addressable pin driver circuit further includes:
at least one feedback circuit communicably coupling the at least one individually addressable pin driver circuit to the electromagnet.

14. A haptic interface driver system, the system comprising:
a first electromagnet;
at least one controller;
a digital bus communicably coupled to the at least one controller; and
an individually addressable first pin driver circuit operably coupled to the first electromagnet and communicably coupled to the digital bus, the individually addressable first pin driver circuit selectively switchable by the at least one controller to one of a number of operating modes, each of the operating modes sufficient to cause the first electromagnet to output a magnetic field.

15. The haptic interface driver system of claim 14 wherein the number of operating modes comprise:
a current sourcing operating mode in which the first pin driver circuit causes the first electromagnet to output a first magnetic field;
a current sinking operating mode in which the first pin driver circuit causes the first electromagnet to output a second magnetic field, the second magnetic field different from the first magnetic field; and
an impulse operating mode in which the first pin driver circuit causes the first electromagnet to output a third magnetic field.

16. The haptic interface driver system of claim 15 wherein the third magnetic field outputted by the first electromagnet is a variable intensity field.

17. The haptic interface driver system of claim 16 wherein the first pin driver circuit includes a number of switched capacitor networks, each of the switched capacitor networks including a number of individually addressable capacitive elements.

18. The haptic interface driver system of claim 17 wherein the impulse operating mode includes operably coupling a switched capacitor network to the first electromagnet; and
wherein the at least one controller causes at least some of the number of individually addressable capacitive elements in the switched capacitor network to substantially simultaneously discharge.

19. The haptic interface driver system of claim 17 wherein the impulse operating mode includes operably coupling a plurality of switched capacitor networks to the first electromagnet; and
wherein the at least one controller causes in an alternating pattern:
some or all of the number of capacitive elements in at least a first of the plurality of switched capacitor networks to discharge while some or all of the number of capacitive elements in at least a second of the plurality of switched capacitor networks charge; and
some or all of the number of capacitive elements in at least the first of the plurality of switched capacitor networks to charge while some or all of the number of capacitive elements in at least the second of the plurality of switched capacitor networks discharge.

20. The haptic interface driver system of claim 15 wherein the at least one controller communicates one or more operating parameters to the first pin driver circuit via the digital bus, the one or more operating parameters including at least data indicative of an intensity of the first magnetic field.

21. The haptic interface driver system of claim 15 wherein the at least one controller communicates one or more operating parameters to the first pin driver circuit via the digital bus, the one or more operating parameters including at least data indicative of an intensity of the second magnetic field.

22. The haptic interface driver system of claim 16 wherein the at least one controller communicates one or more operating parameters to the first pin driver circuit via the digital bus, the one or more operating parameters indicative of at least:
an impulse frequency; and
an intensity of the third magnetic field for at least a portion of an impulse.

23. The haptic interface driver system of claim 14 wherein the individually addressable first pin driver circuit further includes:
at least one feedback circuit communicably coupling the at least one individually addressable pin driver circuit to the electromagnet.

24. A haptic interface method, the method comprising:
selecting by a controller at least one of a number of individually addressable pin coil driver circuits operably coupled to one or more electromagnets, the one or more electromagnets sufficient to cause a physical movement of a surface magnet;
selecting by the controller a pin coil driver circuit operating mode for each of the number of individually addressable pin coil driver circuits, the selected pin coil driver circuit operating mode causing the respective operably coupled electromagnet to generate a magnetic field sufficient to cause the physical movement of the surface magnet;
selecting by the controller one or more pin coil driver circuit operating parameters for each of selected pin coil driver circuit operating modes, the selected one or more pin coil driver circuit operating parameters causing the respective operably coupled electromagnet to generate a magnetic field sufficient to cause the physical movement of the surface magnet; and
communicating by the controller to each respective individually addressable pin coil driver circuit, switching data sufficient to cause the respective pin coil driver circuit to switch into the selected operating mode and data indicative of the one or more respective pin coil driver circuit operating parameters.

25. The haptic interface method of claim 24, further comprising:
displaying a number of user-actuatable devices on a touchscreen display device, each of the number of user-actuatable devices logically associated with a physical movement along at least one of a first axis and a second axis;
receiving by a controller an input indicative of a user actuation of a user-actuatable device; and
responsive to the receipt of the input indicative of the user actuation of the user-actuatable device, determining by the controller the physical movement logically associated with the user-actuatable device.

26. The haptic interface method of claim 25 wherein displaying a number of user-actuatable devices on a touchscreen display device comprises:
displaying a number of user-actuatable devices on a touchscreen display device operably coupled to the surface magnet.

27. The haptic interface method of claim 26 wherein selecting by the controller a pin coil driver circuit operating mode for each of the number of individually addressable pin coil driver circuits comprises:
selecting by the controller a pin coil driver circuit operating mode for each of the number of individually addressable pin coil driver circuits, the pin coil driver circuit operating mode including at least one of: a current sourcing mode, a current sinking mode, or an impulse mode.

28. The haptic interface method of claim 24, further comprising:
communicating to the controller by at least one of the number of individually addressable pin coil driver circuits, data representative of feedback data received by the respective at least one of the number of individually addressable pin coil driver circuits from the operably coupled electromagnet.
